(19) United States
(12) Patent Application Publication
(10) Pub. No.: US 2026/0080308 A1
(43) Pub. Date: Mar. 19, 2026

(54) MULTI-SOURCE TIME SERIES ANOMALY DETECTION

(71) Applicant: SRI International, Menlo Park, CA (US)

(72) Inventors: Subhodev Das, Princeton, NJ (US); Ali Chaudhry, Princeton Junction, NJ (US); Yi Tan, Wimauma, FL (US)

(21) Appl. No.: 19/181,837

(22) Filed: Apr. 17, 2025

Related U.S. Application Data
(60) Provisional application No. 63/635,015, filed on Apr. 17, 2024.

(51) Int. Cl. G06N 20/00; G06F 18/213; G06F 18/23; G06F 18/2431; G06F 123/02

(52) U.S. Cl. CPC G06N 20/00; G06F 18/213; G06F 18/23; G06F 18/2431; G06F 2123/02

(57) ABSTRACT

A method for time series anomaly detection includes: generating, based on multi-source time series data and contextual data, geometric trajectories representing movement of an entity; processing the geometric trajectories and the contextual data to extract a plurality of features, wherein the plurality of features include temporal features, spatial features and contextual features; generating a data structure representing semantic trajectories, wherein each of the semantic trajectories includes the temporal features, the spatial features and the contextual features; generating, using the data structure, based on the contextual features, contextual encodings corresponding to the semantic trajectories and generating, based on the temporal features, temporal encodings corresponding to the semantic trajectories; processing, with a machine learning model, the contextual encodings and the temporal encodings to generate source embeddings representing interdependencies between the semantic trajectories; and outputting, based on the source embeddings, an indication of whether one of the semantic trajectories is anomalous.

This application claims the benefit of U.S. Provisional Patent Application 63/635,015, filed Apr. 17, 2024, which is incorporated by reference herein in its entirety.

### GOVERNMENT RIGHTS

This invention was made with Government support under contract number NRO000-23-C-00-54 awarded by the National Reconnaissance Office. The Government has certain rights in this invention.

### TECHNICAL FIELD

This disclosure is related to machine learning systems, and more specifically to multi-source time series anomaly detection.

### BACKGROUND

Detecting anomalous subsequences in time series data (time ordered sequence of data points) is an important task in areas ranging from manufacturing processes to financial applications to health care monitoring to security and surveillance. The data points of a time series record are one (univariate) or multiple (multivariate) real-valued variables. In many applications, multiple sources (e.g., from different sensors) of time series data may be available capturing the same underlying phenomenon at same or different time instants. High dimensional data offers greater opportunity to detect anomalies reliably, especially when the data points cannot be sampled at regular intervals, provided correlations among the dimensions are established.

Positional time series data (sometimes referred to as “trajectory data”) is data that records the position of an object (person, animal, vehicle, etc.) over time. For example, time series data may be a sequence of coordinates (latitude, longitude, or x, y, z) paired with timestamps. Global Positioning System (GPS) data from a smartphone tracking a movement of a person is time series data. Animal tracking data from collars with GPS sensors is also time series data. Another example of time series data is flight paths of airplanes or ships or satellite trajectories. Weather patterns tracked by radar is yet another example of time series data.

Modern technology may simplify collection of location data. Our lives are inherently mobile, and understanding movement may be important in many fields. For example, raw trajectory mining may focus on the geometric aspects of the movement. Raw trajectory mining may identify patterns such as, but not limited to: common routes, clustering of locations, speed and direction changes, geometric shapes of movement.

### SUMMARY

This disclosure describes techniques for mining multi-source time series data and identifying anomalies therein. Obtaining correlations among dimensional variables of a multivariate time series is not straightforward, and obtaining correlations among different sources is even more difficult. However, a context (or a set of contexts) of the underlying phenomenon influencing the time series data encapsulates rich information about the phenomenon and can enforce a coherent interpretation of the various sources, thereby reducing false positives of anomaly detection.

For example, the techniques of this disclosure may be applied in the context of positional time series data. Prior solutions for raw trajectory mining treat movement as merely a series of points and do not account for causes influencing the movement. In other words, raw trajectory mining may lack context. By contrast, techniques of this disclosure may involve transforming raw time series data into a transformed space, thereby generating a hierarchy of abstractions. This hierarchical abstraction of the input yields semantic concepts. In other words, a computing system according to techniques of this disclosure may convert time series data into a different format to reveal underlying patterns more clearly. This transformation may be important because raw time series data may be noisy and difficult to interpret directly.

The generated hierarchy of abstractions may organize the data into levels of increasing complexity and meaning. In general, this hierarchy may allow the analysis to move from low-level details to high-level concepts. The abstractions are referred to as “trajectories” and capture the states of the underlying phenomenon, influencing the time series data and potentially generating an anomaly, over a sliding temporal window. At higher levels, the techniques involve enriching trajectories with semantics (e.g., labels or other annotations) at various levels of abstractions. These semantic annotations accommodate the multiplicity of views sought for the raw data.

In various aspects of the disclosed techniques, a computing system applies a machine learning (e.g., deep learning) approach that abstracts semantic concepts from the raw time series that are less susceptible to irregularity in data sampling. Additionally, the machine learning approach represents the context as a learnable parameter in such a way that any anomaly is considered as a deviation from expectation only in the learned context. This machine learning approach may also combine information from multiple sources within an end-to-end workflow of the computing system, and in some cases does so without breaking the connections between the different sources in a temporal window. Consequently, this machine learning approach is more robust and offers explanations of the analysis compared to existing approaches.

In addition to the above technical advantages, the techniques may provide one or more other technical advantages that realize at least one practical application. Reliable anomaly detection in time series data is important in many different areas, such as autonomous vehicle operation, understanding of city dynamics and social behaviors, detection of geopolitical hotspots in maritime domain, finance, retail, cybersecurity, and others. Because the machine learning approach may develop an understanding of the underlying phenomena influencing the raw time series data, the techniques may provide an automated means of reliably detecting anomalies to reduce false positives and thereby improve systems that monitor complex phenomena by analyzing multi-source time series data.

In an example, a method for time series anomaly detection includes: generating, based on multi-source time series data and contextual data, one or more geometric trajectories representing movement of an entity; processing the one or more geometric trajectories and the contextual data to extract a plurality of features, wherein the plurality of features include one or more of temporal features, spatial features and contextual features; generating a data structure representing one or more semantic trajectories, wherein each of the one or more semantic trajectories includes at least one of the one or more temporal features, spatial features and the contextual features; generating, using the data structure, based on the contextual features, one or more contextual encodings corresponding to the one or more semantic trajectories and generating, based on the temporal features, one or more temporal encodings corresponding to the one or more semantic trajectories; processing, with a machine learning model, the one or more contextual encodings and the one or more temporal encodings to generate one or more source embeddings representing one or more interdependencies between the one or more semantic trajectories; and outputting, based on the one or more source embeddings, an indication of whether one of the semantic trajectories is anomalous.

In an example, a computing system for time series anomaly detection includes: processing circuitry in communication with storage media, the processing circuitry configured to execute a machine learning system configured to: generate, based on multi-source time series data and contextual data, one or more geometric trajectories representing movement of an entity; process the one or more geometric trajectories and the contextual data to extract a plurality of features, wherein the plurality of features include one or more of temporal features, spatial features and contextual features; generate a data structure representing one or more semantic trajectories, wherein each of the one or more semantic trajectories includes at least one of the one or more temporal features, spatial features and the contextual features; generate, using the data structure, based on the contextual features, one or more contextual encodings corresponding to the one or more semantic trajectories and generate, based on the temporal features, one or more temporal encodings corresponding to the one or more semantic trajectories; process, with a machine learning model, the one or more contextual encodings and the one or more temporal encodings to generate one or more source embeddings representing one or more interdependencies between the one or more semantic trajectories; and output, based on the one or more source embeddings, an indication of whether one of the semantic trajectories is anomalous.

In an example, non-transitory computer-readable storage media having instructions encoded thereon for time series anomaly detection, the instructions configured to cause processing circuitry to: generate, based on multi-source time series data and contextual data, one or more geometric trajectories representing movement of an entity; process the one or more geometric trajectories and the contextual data to extract a plurality of features, wherein the plurality of features include one or more of temporal features, spatial features and contextual features; generate a data structure representing one or more semantic trajectories, wherein each of the one or more semantic trajectories includes at least one of the one or more temporal features, spatial features and the contextual features; generate, using the data structure, based on the contextual features, one or more contextual encodings corresponding to the one or more semantic trajectories and generate, based on the temporal features, one or more temporal encodings corresponding to the one or more semantic trajectories; process, with a machine learning model, the one or more contextual encodings and the one or more temporal encodings to generate one or more source embeddings representing one or more interdependencies between the one or more semantic trajectories; and output, based on the one or more source embeddings, an indication of whether one of the semantic trajectories is anomalous.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is a block diagram illustrating an example system for time series anomaly detection in accordance with one or more techniques of the disclosure.

FIG. 2 is a detailed block diagram illustrating an example computing system, in accordance with one or more techniques of the disclosure.

FIG. 3 is a diagram illustrating different types of trajectories, in accordance with one or more techniques of this disclosure.

FIG. 4 is a conceptual diagram illustrating communication between various modules of the machine learning system of FIGS. 1 and 2, according to one or more techniques described in this disclosure.

FIG. 5 is a detailed block diagram illustrating an example semantic trajectory processing framework, in accordance with one or more techniques of the disclosure.

FIG. 6 is a diagram illustrating that semantic trajectories may be stored in a B-tree data structure, in accordance with one or more techniques of the disclosure.

FIG. 7 illustrates a framework for identifying anomalous trajectories by leveraging data from multiple sources, in accordance with one or more techniques of the disclosure.

FIG. 8 is a flowchart illustrating an example mode of operation for a machine learning system, according to one or more techniques described in this disclosure.

Like reference characters refer to like elements throughout the figures and description.

### DETAILED DESCRIPTION

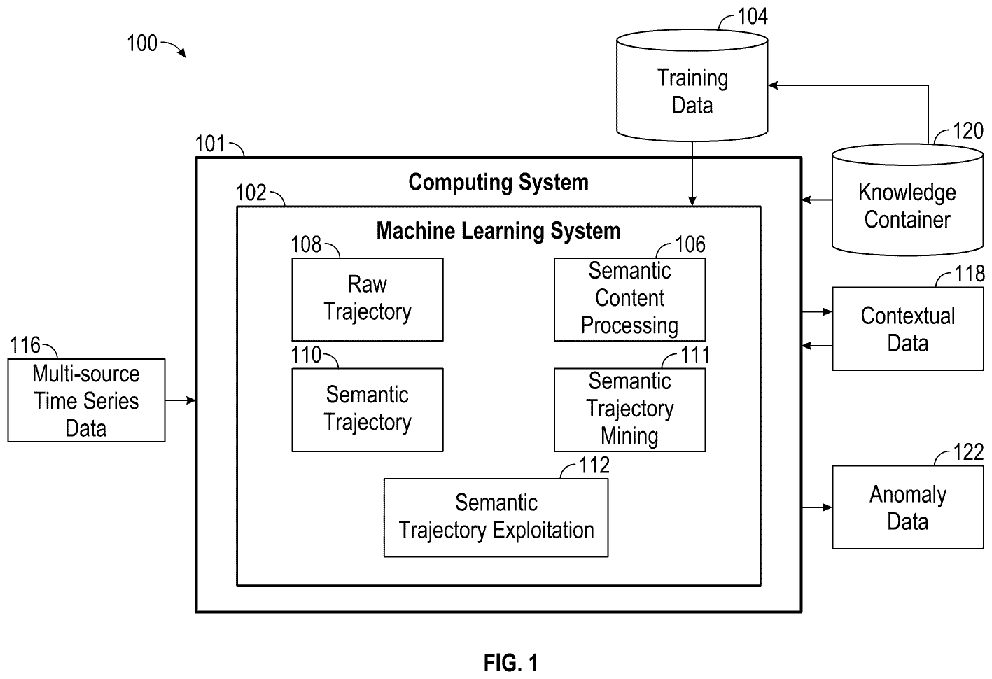

FIG. 1 is a block diagram illustrating an example system for time series anomaly detection in accordance with one or more techniques of the disclosure. As shown, system 100 includes computing system 101 and a knowledge container 120. Knowledge container 120 stores or represents respective domain knowledge models for one or more knowledge domains.

Computing system 101 may utilize knowledge container 120 for the orderly storage and retrieval of various information. Different types of knowledge containers 120 may be used for different kinds of multi-source time series data 116. Knowledge containers 120 may represent and store both rich electronic content (such as events, documents, answers to questions, marketing materials, etc.) and other physical and electronic resources (such as experts, customers, online communities of interest, software applications, etc.). The types of knowledge containers 120 may include but are not limited to: document, question, answer, knowledge consumer, knowledge provider, e-resource and product knowledge containers. Data stored for knowledge container 120 is stored to computer readable storage media.

Computing system 101 may execute Machine Learning (ML) system 102, which may be implemented as software, but may in some examples include any combination of hardware, firmware, and software. In accordance with techniques of this disclosure, ML system 102 may be configured to perform time series data analysis and/or anomaly detection. The disclosed method may identify anomalies or deviations from expected patterns.

In some aspects, machine learning system 102 may create behavioral profiles. ML system 102 may use the interpreted behaviors to provide personalized recommendations or interventions. For example, ML system 102 may recommend optimal routes for commuters. In operation, ML system 102 may provide location-based services based on user preferences. As yet another example, ML system 102 may predict traffic congestion and may suggest alternative routes.

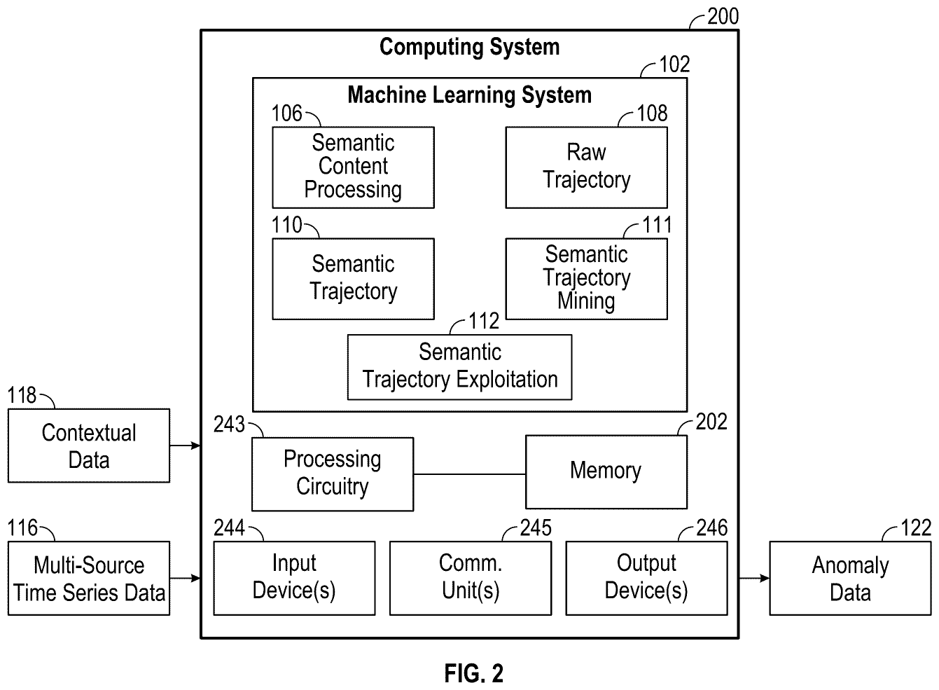

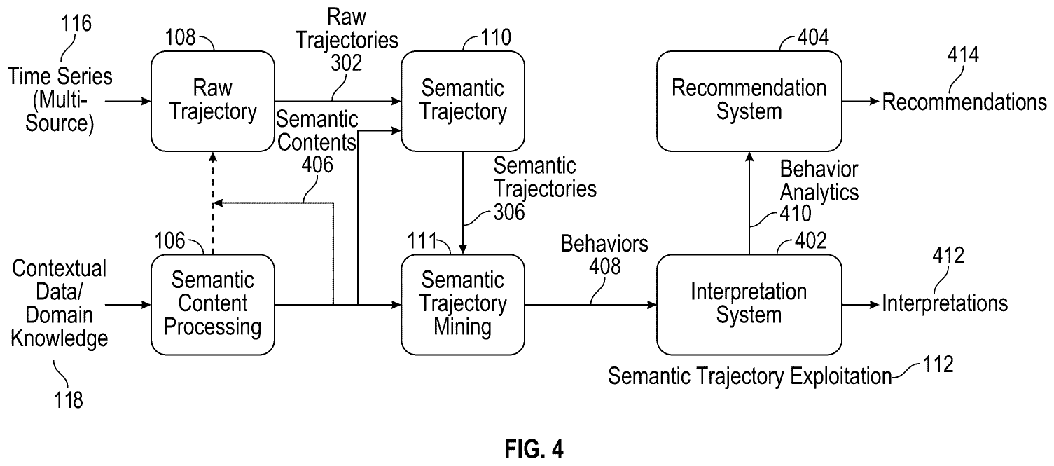

ML system 102 includes semantic content processing module 106, raw trajectory module 108, semantic trajectory module 110, semantic trajectory mining module 111, and semantic trajectory exploitation module 112. Functionality of modules 106-112 is described in greater detail below, in conjunction with FIGS. 2 and 4.

Raw trajectory module 108 may be configured to receive and process multi-source time series data 116. The term “multi-source time series data,” as used herein, refers to the various sensor data or measurements that may contribute to the raw (geometric) trajectory. In simple terms, a trajectory is a sequence of states that an object or system goes through over time. In an example of the disclosed techniques, at the lowest level of the hierarchy, the trajectories may be called “raw trajectories” or “geometric trajectories.” These geometric trajectories may capture the basic, raw movements or changes in the data, like the position of an object in space over time. The geometric trajectories may be the most direct representation of the transformed data. The multi-source time series data 116 may include, but is not limited to: GPS coordinates (latitude, longitude, altitude), accelerometer data (acceleration in different directions), gyroscope data (rotation rates), Wi-Fi or Bluetooth signal strength and/or other relevant sensor readings. Contextual data 118 may also come from diverse sources (GIS layers, social media, weather APIs, economic data, full-motion video, etc.), each with its own format, structure, and quality. Integrating these disparate sources may be challenging. Contextual data 118 should be aligned with the timestamps of the raw trajectory.

As noted above, raw trajectories may lack context. For example, a trip to a grocery store, and a trip to a hospital may look geometrically similar, but may have very different meanings. Raw trajectories may often be limited to a single level of detail. Advantageously, semantic trajectories may enrich raw trajectories with contextual information and semantic annotations. The components of the semantic trajectory may include raw trajectories and contextual data 118. The raw trajectory component may include the basic location and time data. The contextual data 118 may include external information that provides context, such as, but not limited to, land use data (residential, commercial, park), road network information, weather conditions, social media activity, and points of interest data.

Temporal alignment may require precise time synchronization and handling of data with varying temporal resolutions. Contextual data 118 should be spatially aligned with the trajectory's coordinates. Spatial alignment may involve, for example, geocoding, spatial indexing, and handling spatial uncertainties.

Manual annotation may be time-consuming and expensive, especially for large datasets. Automated annotation methods often rely on machine learning, which may require labeled training data 104. In many cases, such labeled data may be scarce or nonexistent.

Contextual data 118 may be very noisy, and at least some of contextual data 118 may be irrelevant to a particular trajectory. Determining what context is relevant, and how to use that context may be a difficult problem for ML system 102. As an example, ML system 102 may automatically label a trajectory segment as “shopping” based on proximity to a shopping mall and time of day. In an aspect, ML system 102 may infer a user's mode of transportation (walking, driving, cycling) from speed and road network data. As yet another example, ML system 102 may add weather information to an animal migration trajectory and may then relate the weather information to changes in the migration pattern.

As yet another non-limiting example, meaningful labels may be assigned to segments of the raw trajectory, such as, but not limited to: “Going to work.”; “Shopping.”; “Visiting a friend.”; “Migration.”; “Foraging.” Semantic trajectories may move beyond “where” to “what” and “why.” Semantic trajectories may enable the discovery of behavioral patterns that are location-independent.

For example, a “commute” may be recognized regardless of the specific route. Semantic trajectories may allow for multi-level granularity. In many real-world scenarios, semantic trajectories may allow analysis of the overall journey, or very specific actions taken during the journey. Semantic trajectories may allow for the modeling of higher-level concepts.

Semantic trajectories may enable more accurate predictions and recommendations. Analysis of semantic trajectories may reveal insights into the behavior of the mover. For example, analysis of semantic trajectories may help understand daily routines, identify anomalous behavior, study animal migration patterns, and understand traffic flow. Some semantic trajectories may enable predictions of future movements, based on past behavior.

As disclosed techniques move up the hierarchy, the trajectories may be enriched with semantics. In other words, the trajectories may be given more meaning and context. For example, instead of just knowing the object's position, the disclosed system may recognize that the object is moving towards a target or performing a specific action.

For example, the disclosed techniques may learn to recognize patterns and assign labels to them. As described herein, the disclosed system may develop an understanding of the “why” and not just the “what”. In one aspect, the raw data may be sensor readings of an object's position over time. The raw data may be converted into a format that highlights the movement patterns of the object. In another aspect, the disclosed system may identify the position of the object at each point in time, creating a series of coordinates that form a trajectory. The disclosed system may provide various interpretations of the same data, depending on the desired perspective. By attaching semantic labels (meaningful descriptions) to the trajectories, the disclosed system may allow users to analyze the data from different angles. For example, one view might focus on the speed of the object, while another might focus on direction or overall behavior of the object. In some cases, the disclosed framework may be used for flexible analysis.

Semantic trajectories may be inherently ontological because semantic trajectories may represent real-world entities and relationships of real-world entities in a structured, machine-readable way. Trajectory data may be massive, especially for long-term monitoring or large populations. Semantic trajectories may involve complex relationships between, for example spatial, temporal, and semantic attributes.

Traditional database systems may not be well-suited for handling the complexity and scale of semantic trajectory data. For example, a data model may be needed to represent the structure and semantics of trajectories, contextual data, and annotations. The data model should be flexible enough to accommodate diverse data sources and application domains. For example, ontology-based models (e.g., using Resource Description Framework (RDF) or Web Ontology Language (OWL)) may be beneficial for representing semantic relationships.

It should be noted that a query language may be needed to retrieve semantic trajectories or parts thereof based on spatial, temporal, and semantic criteria. In addition, the language should support complex queries involving spatial relationships (e.g., “find all trajectories that pass through a certain area”), temporal relationships (e.g., “find all trajectories that occur during rush hour”), and semantic relationships (e.g., “find all trajectories that involve shopping”). In an example, spatial-temporal databases, and graph databases may be used by ML system 102.

In an example, time series data 116 may be sparse due to gaps in GPS coverage, sensor failures, or intermittent data collection. Contextual data 118 may also be sparse, with missing or incomplete information.

In an example, techniques like interpolation, Kalman filtering, or machine learning models may be used to fill in missing data points. In other words, representing uncertainty in the data using probabilistic models may account for sparsity and limited quality. In an example, combining data from multiple sources may help ML system 102 fill in gaps and improve data coverage. Raw trajectory data (e.g. time series data 116) may contain noise, outliers, or inaccuracies. Contextual data 118 may be outdated, inconsistent, or unreliable. In an example, techniques like outlier detection, smoothing, and data validation may be used to improve data quality.

Assigning confidence scores or quality metrics to data points by ML system 102 may help identify and mitigate the impact of low-quality data. Using algorithms that are robust to noise and outliers may improve the accuracy of mining and interpretation.

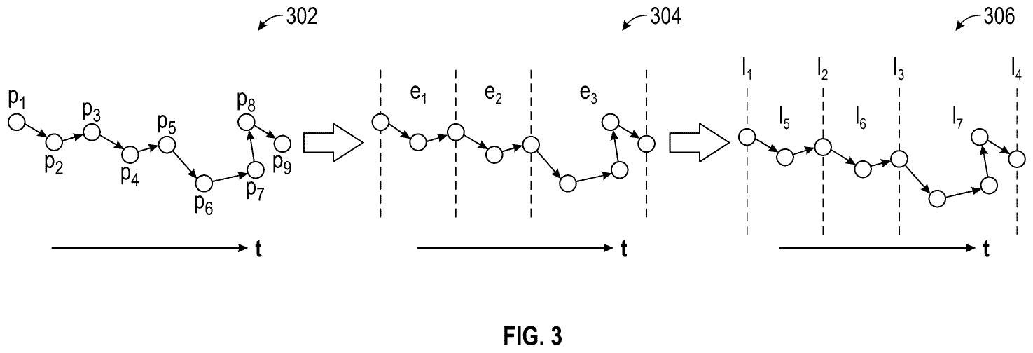

In the example of FIG. 1, anomaly data 122 may occur in applications where users want to hide their movements or deceive tracking systems. Anomaly detection may include techniques to identify unusual or suspicious patterns in the data. In other words, data validation may include cross-referencing data with trusted sources to detect inconsistencies. In an example, without context, trajectory data 302 shown in FIG. 3 may be just a sequence of coordinates. Context may provide the “why” behind the movement and may enable meaningful interpretation. Context may not be always explicitly given. In an example, context may be induced from the structure in the data itself. For example, patterns in movement may reveal typical routines or activities. In an example, behavioral (intrinsic) attributes may be properties of the data sample itself, such as, but not limited to, speed, direction, acceleration, or turning angles. Behavioral attributes may be derived directly from the trajectory data. In an example, contextual (extrinsic) attributes may be properties of the environment or external factors, such as, but not limited to, land use, weather, traffic, or social events. Contextual attributes may be obtained from external sources.

In an example, both types of attributes (behavior and contextual) may be needed to fully understand a trajectory. Attention mechanisms may be used by ML system 102 to focus on the most relevant parts of the data, especially in complex or noisy datasets. In an example, attention mechanisms may assign weights to different data points or features, indicating their importance. In semantic trajectory mining performed by semantic trajectory mining module 111, attention mechanisms may be used to: identify the most relevant contextual features for a given trajectory segment.

In an example, attention mechanisms may focus on the most informative parts of a long trajectory. For example, attention mechanisms may weight the importance of different sensor inputs.

In an example, attention-guided contextual learning techniques may allow ML system 102 to selectively focus on the most relevant contextual information for a given data sample (e.g., a trajectory segment). The ML system 102 may learn to assign different weights to different sources of contextual information, indicating their relative importance. In an example, the weights may not be fixed; the weights may vary depending on the specific data sample and the task at hand.

In an example, dynamic context may enable the ML system 102 to adapt to different situations and focus on the most relevant context. In practical application, a data sample may contain both behavioral (intrinsic) and contextual (extrinsic) attributes. Advantageously, behavioral attributes may be derived directly from the trajectory (speed, direction, etc.).

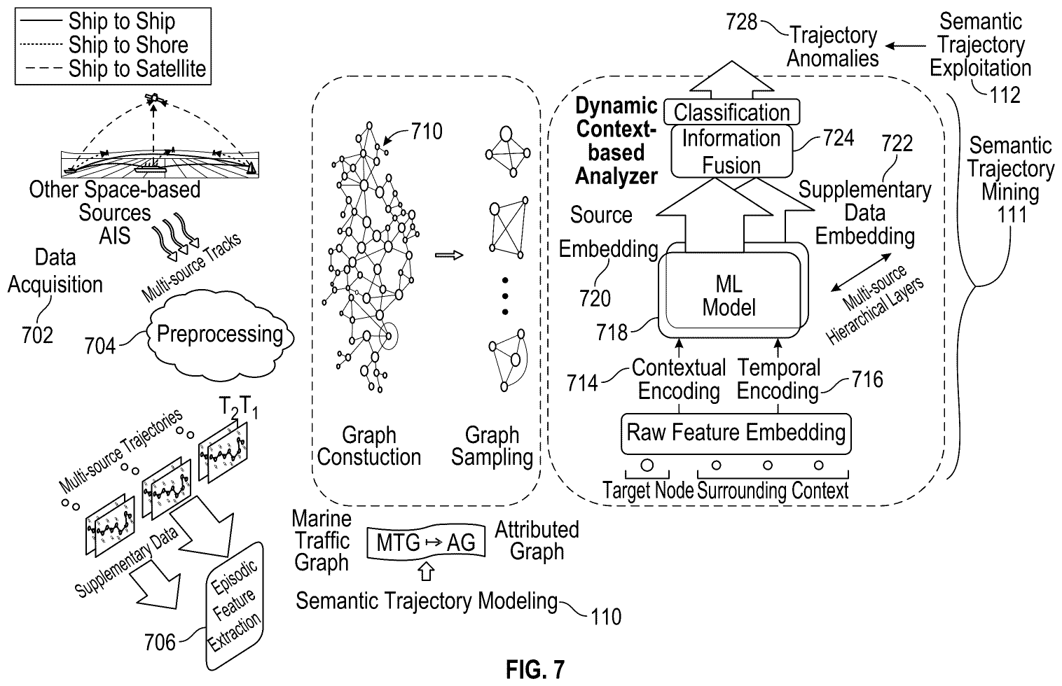

FIG. 2 is a block diagram illustrating an example computing system 200. In an aspect, computing system 200 may comprise an instance of the computing system 100. To process multi-source time series data 116 and contextual data 118, as shown, computing system 200 includes processing circuitry 243 and memory 202 for executing ML system 102 having semantic content processing module 106, raw trajectory module 108, semantic trajectory module 110, semantic trajectory mining module 111 and semantic trajectory exploitation module 112. Each of semantic content processing module 106, raw trajectory module 108, semantic trajectory module 110, semantic trajectory mining module 111 and semantic trajectory exploitation module 112 may include one or more machine learning models. For example, semantic trajectory mining module 111 may include a Sequence Processing Neural Network (SPNN) model, shown as ML model 718 in FIG. 7.

Computing system 200 may be implemented as any suitable computing system, such as one or more server computers, workstations, laptops, mainframes, appliances, cloud computing systems, High-Performance Computing (HPC) systems (i.e., supercomputing) and/or other computing systems that may be capable of performing operations and/or functions described in accordance with one or more aspects of the present disclosure. In some examples, computing system 200 may represent a cloud computing system, a server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster. Computing system 200 may represent an instance of computing system 100 of FIG. 1.

In some examples, at least a portion of system 200 is distributed across a cloud computing system, a data center, or across a network, such as the Internet, another public or private communications network, for instance, broadband, cellular, Wi-Fi, ZigBee, Bluetooth® (or other personal area network-PAN), Near-Field Communication (NFC), ultrawideband, satellite, enterprise, service provider and/or other types of communication networks, for transmitting data between computing systems, servers, and computing devices.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. Processing circuitry 243 of computing system 200 may implement functionality and/or execute instructions associated with computing system 200. Computing system 200 may use processing circuitry 243 to perform operations in accordance with one or more aspects of the present disclosure using software, hardware, firmware, or a mixture of hardware, software, and firmware residing in and/or executing at computing system 200. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Memory 202 may comprise one or more storage devices. One or more components of computing system 200 (e.g., processing circuitry 243, memory 202) may be interconnected to enable inter-component communications (physically, communicatively, and/or operatively). In some examples, such connectivity may be provided by a system bus, a network connection, an inter-process communication data structure, local area network, wide area network, or any other method for communicating data. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random access memories (RAM), dynamic random-access memories (DRAM), static random access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 202 may store program instructions and/or data associated with one or more of the modules described in accordance with one or more aspects of this disclosure.

Processing circuitry 243 and memory 202 may provide an operating environment or platform for one or more modules or units (e.g., semantic content processing module 106, raw trajectory module 108, semantic trajectory module 110, semantic trajectory mining module 111 and semantic trajectory exploitation module 112), which may be implemented as software, but may in some examples include any combination of hardware, firmware, and software. Processing circuitry 243 may execute instructions and the one or more storage devices, e.g., memory 202, may store instructions and/or data of one or more modules. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute computing system 100 using virtualization modules, such as a virtual machine or container executing on underlying hardware. One or more of such modules may execute as one or more services of an operating system or computing platform. Aspects of computing system 100 may execute as one or more executable programs at an application layer of a computing platform.

One or more input devices 244 of computing system 200 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine.

One or more output devices 246 may generate, transmit, or process output. Examples of output are tactile, audio, visual, and/or video output. Output devices 246 may include a display, sound card, video graphics adapter card, speaker, presence-sensitive screen, one or more USB interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 may include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, 5G and Wi-Fi® radios found in mobile devices as well as Universal Serial Bus (USB) controllers and the like.

In the example of FIG. 2, raw trajectory model 110 and semantic content processing module 106 may receive input data and semantic trajectory exploitation module 112 may generate output data. The input data and the output data may contain various types of information. For example, the input data may include (multi-source time series data 116 and contextual data 118 as well as domain knowledge). The output data may include anomaly data 122 as well as interpretations and/or recommendations generated by semantic trajectory exploitation module 112, for example.

FIG. 3 is a diagram illustrating different types of trajectories, in accordance with one or more techniques of this disclosure. More specifically, FIG. 3 illustrates geometric or spatial trajectory 302, which may consist of raw time series data 116. In geometric trajectory 302 pᵢ represents a particular position i. FIG. 3 also illustrates structured trajectory 304. In structured trajectory 304, eᵢ represents an episode i. Finally, FIG. 3 also illustrates semantic trajectory 306. As shown in FIG. 3, semantic trajectory 306 may include one or more semantic labels lᵢ. For example, semantic trajectory 306 may include place names (e.g., labels l₁-l₄) and route names (e.g., labels l₅-l₇). Different types of trajectories are discussed in greater detail below in conjunction with FIGS. 4-8.

FIG. 4 illustrates communication between various modules of the machine learning system 102 of FIGS. 1 and 2, according to one or more techniques described in this disclosure.

Semantic content processing module 106 may be configured to process contextual data 118 and domain knowledge to extract semantic meaning. Contextual data 118 and domain knowledge may be inputs to this module. Domain knowledge may include, but is not limited to rules, ontologies, or other forms of expert knowledge about the application domain.

Domain knowledge may help to guide the learning of the semantic content processing module 106 and may improve the accuracy of semantic interpretation. Semantic content processing module 106 may use attention mechanisms to weigh the importance of different contextual inputs.

Global attention techniques may typically consider all available contextual information. Weights may be assigned to all contextual sources. The final context vector may be derived by combining all weighted contextual features. This technique may be useful when all contextual sources are potentially relevant.

According to aspects of the disclosure, semantic content processing module 106 may also use local attention techniques. That is, in this case, only a subset of the available contextual information (contextual data 118) may be considered. However, weights may be assigned to a selected subset of contextual sources. For example, the final context vector may be derived by combining the weighted features from the selected subset. This technique may be useful when some contextual sources are irrelevant or redundant, or when computational efficiency is a concern. Local attention may be used to focus on context that is close in time, or space to the current datapoint.

In an example, the ML system 102 may analyze a trajectory segment representing a person walking in a city. Global attention mechanism of the semantic content processing module 106 may consider all contextual information, such as, but not limited to, weather, traffic, land use, and social media activity. Local attention mechanism of the semantic content processing module 106 may focus only on the land use and nearby points of interest, as these may likely to be the most relevant contextual factors for a pedestrian.

Semantic content processing module 106 may combine the weighted contextual features with the behavioral features to generate semantic contents 406 (e.g., semantic annotations or interpretations).

ML system 102 may use raw trajectory module 108 to process and refine the raw sensor data (e.g., time series data 116) to produce a more accurate and complete representation of the geometric trajectory 302, in accordance with techniques described herein. This process may involve, for example, filtering and smoothing noisy sensor readings. Raw trajectory module 108 may interpolate missing data points. Raw trajectory module 108 may estimate velocity and acceleration.

Raw trajectory model 108 may be focused on the geometric and kinematic properties of the movement. The result generated by the raw trajectory module 108 may be a sequence of refined spatial-temporal coordinates, potentially with associated velocity and acceleration information.

As noted above, semantic content processing module 106 may take the contextual data 118 as input and may generate semantic contents 406, such as semantic annotations. Semantic content 406 may include but is not limited to: activity labels (e.g., “walking,” “driving,” “shopping”), place labels (e.g., “home,” “work,” “restaurant”), behavioral patterns (e.g., “commute,” “leisure,” “errand”). In other words, this module may be focused on the meaning and purpose of the movement. The semantic contents 406 may be used as an optional input to the raw trajectory module 108 to improve data filtering or interpolation.

For example, knowing that a user is driving may help to filter out noise that is characteristic of walking. Essentially, the semantic information may be used to refine the raw geometric trajectory 302.

In an aspect, the semantic trajectory model 110 may take the refined raw trajectories (e.g. geometric trajectories 302) and potentially semantic contents 406 as input and may generate higher-level semantic trajectories 306. Semantic trajectories 306 may be enriched representations of the geometric trajectories 302, including, but not limited to: sequences of semantic annotations, contextual information associated with each trajectory segment and behavioral profiles or patterns (behavioral features). In a non-limiting example, this module may be focused on the comprehensive understanding of the movement.

Semantic trajectories 306 may be the enriched movement representations produced by the semantic trajectory module 110, containing raw trajectory data, contextual data, and semantic annotations. Semantic trajectory mining module 111 may be configured to extract patterns, relationships, and insights from the collection of semantic trajectories 306. Semantic trajectory mining module 111 may be configured to discover: frequent movement patterns, typical routines or habit, clusters of similar behaviors, anomalous or unexpected movements, correlations between movement and contextual factors, and the like. This module may use data mining techniques to distill knowledge from large datasets of semantic trajectories 306. In other words, the output of semantic trajectory mining module 111 may be a set of identified behaviors 408. These behaviors 408 may include, but are not limited to: recurring patterns of activity, typical movement routines, social interaction patterns, migration patterns and foraging patterns.

The identified behaviors 408 may represent higher-level abstractions of the movement data, capturing the underlying purpose and meaning.

As shown in FIG. 4, interpretation system 402 may be a component of semantic trajectory exploitation module 112. The interpretation system 402 may take the discovered behaviors 408 as input and may provide human-understandable explanations and insights (e.g., interpretations 412).

The interpretation system 402 may be configured to: explain the meaning and significance of the identified behaviors 408, provide context and background information, generate summaries or reports and visualize the behaviors 408 in a meaningful way. The interpretation system 402 may bridge the gap between machine-generated behaviors 408 and human understanding. The output of the interpretation system 402 may be a set of human-understandable interpretations 412 of behaviors 408. The interpretations 412 may include, but are not limited to: narrative descriptions of movement patterns, explanations of the factors influencing movement, predictions of future movements, visualizations of movement patterns and behaviors 408.

As yet another example, behavior analytics 410 may be the output of interpretation system 402, providing human-understandable insights into the observed behaviors 408.

In an aspect, the recommendation system 404 may be another component of the semantic trajectory exploitation module 112 and may use the behavior analytics 410 to generate personalized recommendations 414 or suggestions. In an aspect, the recommendation system 404 may be configured to: predict future actions or needs based on past behaviors, suggest relevant services or products, provide personalized guidance or assistance, optimize routes or schedules. As an example, if the interpretation system 402 reveals that a user frequently visits coffee shops in the morning, the recommendation system 404 may suggest new coffee shops nearby.

If the interpretation system 402 detects a migratory pattern of an animal, the recommendation system 404 may recommend conservation actions. As yet another example, if the interpretation system 402 identifies traffic congestion patterns, the recommendation system 404 may recommend alternate routes as a component of recommendations 414. In other words, recommendations 414 may be the actionable suggestions or guidance provided by the recommendation system 404. Recommendations 414 may be tailored to the individual user or situation, taking into account their past behaviors and current context.

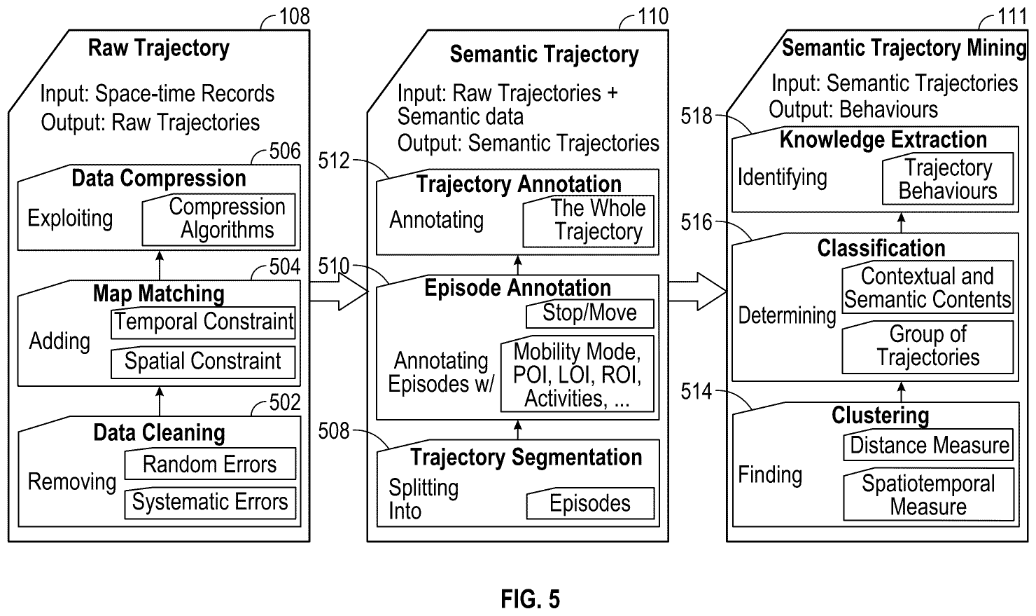

FIG. 5 is a detailed block diagram illustrating an example semantic trajectory processing framework, in accordance with one or more techniques of the disclosure. The raw trajectory module 108 may be configured to organize and structure the raw sensor data in a way that facilitates subsequent trajectory enrichment.

In general, the raw trajectory module 108 may prepare the data for the semantic trajectory module 110 and semantic trajectory mining module 111. To overcome the aforementioned challenges of raw trajectory data, an important part of this process may be data cleaning 502, which may involve removing errors and inconsistencies from the raw sensor readings. The data cleaning 502 may also involve filtering out noise and outliers.

According to the disclosed techniques, clean and structured raw data may be important for accurate semantic trajectory modeling. According to the disclosed techniques, errors or inconsistencies in the raw data may propagate through the pipeline, leading to inaccurate interpretations 412 and recommendations 414.

Generally, raw trajectory module 108 may better ensure the raw trajectory data is as accurate and reliable as possible before further processing. Overall, raw trajectory module 108 may be configured to remove different types of errors during data cleaning 502, such as but not limited to: random errors, systematic errors and errors in state estimations. In this case, random errors may be unpredictable fluctuations in sensor readings, often due to noise or environmental factors. GPS receiver positional errors caused by atmospheric interference or signal reflections are examples of random errors. Raw trajectory module 108 may employ state estimation techniques (e.g., Kalman filtering) to mitigate random errors. Systematic errors may be consistent biases or inaccuracies caused by limitations in the sensor or system itself. For example, a sensor with a known calibration error, or a GPS receiver that consistently underestimates altitude in certain environments are systematic errors. In other words, systematic errors may often require calibration or correction procedures. In addition, a common source of errors is in the estimation of the state of the object, particularly its spatial position. GPS coordinates are a prime example of errors in state estimation, but errors may also occur in velocity, acceleration, and orientation measurements.

As illustrated in FIG. 5, in addition to data cleaning 502, raw trajectory module 108 may perform map matching 504 and data compression 506 using techniques described below. For example, the raw trajectory module 108 may perform map matching 504 to improve the accuracy of trajectory data by aligning it with a digital map or road network.

In accordance with the techniques of the present disclosure, map matching 504 may use spatial, temporal, or spatiotemporal constraints to ensure that the trajectory is consistent with the map. In other words, raw trajectory module 108 may use spatial constraints to restrict the raw trajectories 302 to lie on roads or paths. Generally, map matching 504 may involve acquiring a digital representation of the road or waterway network. Common sources and methods of acquiring digital representation of the navigation network may include, but are not limited to: OpenStreetMap (OSM), commercial data providers and governmental agencies. The OSM may be a free and editable map of the world. Companies may offer services that provide detailed, proprietary navigation data. National mapping agencies (e.g., USGS) may often provide publicly available data. In other words, once obtained, the raw data may need to be processed to create a graph structure suitable for navigation and map matching 504. In an aspect, map matching 504 may be the process of correlating raw location observations (e.g., GPS points) with the correct road or waterway segments in the navigation network. In one non-limiting example, map matching 504 may be important for: improving the accuracy of location data, determining the actual route taken, enabling location-based services.

In an example, raw trajectory module 108 may consider the speed and direction of movement (temporal constraints) to ensure that it is physically possible to travel along the matched path. Raw trajectory module 108 may combine spatial and temporal constraints (spatiotemporal constraints) to ensure that the raw trajectory 302 is both spatially and temporally consistent with the map. It should be noted that map matching 504 may reduce positional errors. In other words, map matching 504 may improve the accuracy of speed and travel time estimates.

In addition, raw trajectory module 108 may perform data compression 506 to reduce the size of the trajectory dataset while preserving essential characteristics of the trajectory dataset. Data compression 506 may reduce storage requirements. In an example, data compression 506 may speed up data processing and analysis. In other words, in the context of semantic trajectory processing, data compression 506 may enable computations with limited resources. The compression and decompression algorithms should be computationally efficient.

In most cases, the compressed raw trajectory 302 should closely resemble the original trajectory. For example, the overall trend or pattern of raw trajectory 302 should not be distorted by raw trajectory module 108.

Semantic trajectory module 110 may add semantics to raw trajectories 302 by linking the spatiotemporal units with knowledge from geographic and application domain data. Initially, semantic trajectory module 110 may perform trajectory segmentation 508, which may be an important step for identifying key points of interest within the raw trajectory 302. In this trajectory segmentation 508 step, semantic trajectory module 110 may divide the continuous data into meaningful segments. In other words, semantic trajectory module 110 may represent raw trajectory 302 as a sequence of alternating stop and move episodes. For example, in structured trajectory 304 shown in FIG. 3, e; represents an episode.

In an example, stops may be identified by “unchanged” locations over a minimal time duration. For example, the term “unchanged” locations may be defined using a distance threshold (e.g., within a radius of 10 meters). The term “minimal time duration” may need to be determined based on the application. In other words, a 5-minute stop, for example, might be significant for a pedestrian, but not for a high-speed train. Additionally, algorithms like DBSCAN or other clustering techniques may be used by semantic trajectory module 110 to identify stop clusters. In other words, move episodes may then be the segments between identified stop clusters. GPS noise may lead to false stops. Filtering techniques (e.g., Kalman filter) may be necessary for trajectory segmentation 508. The choice of distance and time thresholds may significantly impact segmentation results. In an aspect, distance and time thresholds might be configurable parameters. In an example, for raw trajectories 302 with low sampling rates, accurate stop detection may be challenging. Therefore, interpolation may need to be used by semantic trajectory module 110.

In the example illustrated in FIG. 5, semantic trajectory module 110 may perform episode annotation 510 next. As used herein, the term “episode annotation” 510 refers to the step of enriching each segmented episode with relevant semantic information. It should be noted that episodes may be defined as “stop” or “move” based on the trajectory segmentation 508 results.

In an aspect, semantic trajectory module 110 may be a machine learning model (e.g., a classifier) that is trained to predict the mode of transportation based on speed, acceleration, and other features. Geographic data (e.g., road networks) may provide clues (e.g., cars are likely to travel on roads). Sensor data (e.g., accelerometer, gyroscope) may be used to infer modes like walking or cycling. Advantageously, semantic trajectory module 110 may use databases (e.g., Google Places, OpenStreetMap) to identify nearby Points Of Interest (POIs). Spatial proximity may be one of the considered factors.

According to one or more disclosed techniques, semantic trajectory module 110 may also annotate LOIs (Lines of Interest), which may include, but are not limited to, road networks, rivers, railways and the like. During the episode annotation 510 step, as shown in FIG. 5, semantic trajectory module 110 may also annotate ROI (Regions of Interest), which may include, but are not limited to, administrative boundaries, parks, or user-defined regions. In one example, spatial containment may be used to determine if an episode falls within a ROI.

Activity annotation may be more challenging for semantic trajectory module 110. Furthermore, activity annotation may require integration of diverse data sources. According to the disclosed techniques, POI categories may provide clues (e.g., a stop at a restaurant may suggest eating). Social media data (e.g., check-ins, photos) may reveal user activities. Contextual data 118 (e.g., time of day, day of week) may also be important. Semantic trajectory module 118 may use one or more machine learning models to infer activities based on combined features. Accuracy of geographic databases and activity recognition models may be important. Contextual data 118 (e.g., weather) may significantly improve accuracy of episode annotation 510.

In an aspect, semantic trajectory module 110 may also assign overall semantic labels to the entire trajectory (trajectory annotation 512). Start and end of the semantic trajectory 306 may be determined from the first and last timestamps of the raw trajectory 302. The disclosed techniques may automatically analyze the sequence of annotated episodes of structured trajectory 304, which may reveal the overall purpose of the raw trajectory 302 (e.g., “commute to work,” “shopping trip,” “tourist sightseeing”).

In an example, semantic trajectory module 110 may perform aggregation of the POI's visited. In an aspect, the level of detail in trajectory annotation 512 may depend on the application. User feedback may be valuable for validating and refining automatic trajectory annotations 512.

In one example, semantic trajectory mining module 111 may cluster groups trajectories that exhibit similar behavioral patterns, which may reveal underlying behavioral trends/features (clustering 514). Semantic trajectory mining module 111 may use distance metrics to implement clustering 514 techniques.

Spatial distance may measure the geometric similarity between semantic trajectories 306 (e.g., Euclidean distance, Dynamic Time Warping (DTW), Fréchet distance). Temporal distance may consider the temporal alignment of trajectory points (e.g., DTW with temporal constraints). The contextual distance measure may incorporate semantic information (e.g., POI visits, transportation modes) into the distance calculation. Semantic trajectory mining module 111 may utilize one or more clustering algorithms such as, but not limited to, partitioning based techniques (e.g., k-means, k-medoids), density-based techniques (e.g., DBSCAN, OPTICS), and hierarchical techniques (e.g., agglomerative clustering). The partitioning-based techniques may be suitable for identifying well-defined clusters.

In one example, density-based techniques may be effective for discovering clusters of arbitrary shapes and handling noise. The hierarchical techniques may create a hierarchy of clusters, revealing different levels of granularity.

The choice of distance metric may significantly impact clustering results. Parameter tuning (e.g., number of clusters, distance thresholds) may be important for semantic trajectory mining module 111 to perform accurate clustering 514. In some cases, clustering 514 may reveal common movement patterns, such as, but not limited to, commuting routes, popular tourist destinations, or anomalous behaviors.

Semantic trajectory mining module 111 may also perform classification 516 by assigning semantic labels to semantic trajectories 306 or to segments of semantic trajectories 306, and by enabling the identification of specific behaviors. In an aspect, semantic trajectory mining module 111 may extract relevant features from semantic trajectories 306, such as, but not limited to: speed, acceleration, and direction; POI visits and dwell times; transportation modes; and temporal patterns.

In one example, semantic trajectory mining module 111 may employ non-parametric classification algorithms (e.g., k-nearest neighbors (k-NN)) and mathematical models (e.g., neural networks). More specifically, the non-parametric techniques may classify semantic trajectories 306 based on the labels of their nearest neighbors. Each mathematical model may learn complex relationships between features and labels. Deep learning techniques may be powerful when large datasets of semantic trajectories 306 are available.

The quality of training data 104 may be important for accuracy of classification 516 performed by semantic trajectory mining module 111. In the context of classification 516, feature selection and engineering may play an important role.

In an aspect, results of classification 516 may be used the semantic trajectory mining module 111 during knowledge extraction 518 step to identify specific behaviors, such as, but not limited to “commuting,” “sightseeing,” or “suspicious activity.” Semantic trajectory mining module 111 may also perform identification which may involve extracting high-level knowledge and behavioral patterns from clustered and classified semantic trajectories 306.

For example, semantic trajectory mining module 111 may employ sequence mining algorithms to identify frequent movement patterns. Semantic trajectory mining module 111 may also employ association rule mining, which may discover relationships between trajectory features and behaviors.

Advantageously, semantic trajectory mining module 111 may develop a complex extended entity-relationship model to represent semantic trajectories 306. In other words, semantic trajectory mining module 111 may map the model to a set of relational tables, for example, for efficient storage and querying. In one example, semantic trajectories 306 may contain not only the raw location data, but also the context of the movement, such as, but not limited to, the purpose of the trip, the mode of transportation, and the activities performed. In this context, visualization tools may be important for exploring and interpreting extracted patterns.

It should be noted that in yet another example, a semantic trajectory model generated by semantic trajectory module 110, may be one of the components to bind all of the data together. The semantic trajectory model may provide a structured representation of trajectory data, incorporating semantic information and relationships. The components of the semantic trajectory model may include but are not limited to entities, relationships and attributes. The entities may include, but are not limited to, trajectory points, stops, moves, POIs, users, and activities.

In various examples, relationships may be spatial relationships (e.g., proximity), temporal relationships (e.g., sequence), and semantic relationships (e.g., visits, activities). Accordingly, attributes may include but are not limited to location, timestamp, speed, acceleration, transportation mode, and activity type. Each entity and relationship may be represented as a table. Foreign keys may be used to establish relationships between tables.

The disclosed techniques may leverage symbolic trajectories, which may offer a lightweight and versatile method for associating semantic information with movement data. Symbolic trajectories may prioritize simplicity and flexibility, making the symbolic trajectories suitable for a wide range of applications. Instead of complex data structures, semantic trajectories mining module 111 may utilize symbolic trajectories to represent semantic information as a sequence of time-labeled pair.

In one possible implementation, each pair (tⱼ, lⱼ) may indicate that the trajectory has label lⱼ during the time interval tⱼ. The time intervals may be disjoint and may be ordered chronologically, ensuring a clear and unambiguous representation of the trajectory's semantic evolution. For example, a symbolic trajectory may be represented as [symbol] (t₁, l₁), . . . (tₙ, lₙ) [symbol] . The tⱼ may be a time interval (e.g., [start_time, end_time]). The lⱼ may be a label, typically a short string representing a semantic category (e.g., “home,” “work,” “shopping,” “walking,” “driving”).

A symbolic trajectory may be easy to understand and implement. Therefore, a symbolic trajectory may represent various types of semantic information (contextual, domain-specific). A semantic trajectory may capture changes in semantic context over time. Symbolic trajectories may lend themselves well to Object-Relational Mapping (ORM), simplifying database interactions and query formulation.

In an example, a symbolic trajectory might be represented as:
([09:00, 09:30], “home”)
([09:30, 10:00], “driving”)
([10:00, 12:00], “work”)
([12:00, 13:00], “lunch”)
([13:00, 17:00], “work”)
([17:00, 17:30], “driving”)
([17:30, 18:00], “home”)
   In should be noted that in this example, the symbolic trajectory may show a typical workday of a user, including commuting and lunch. Advantageously, for example, ORM may allow for expressive queries such as, but not limited to: “Find all trajectories that include a ‘shopping’ label between 14:00 and 16:00.” Standard SQL or ORM query languages may be used to perform complex temporal and semantic filtering.

The simple structure may simplify storage and retrieval of symbolic trajectories from relational databases. Sequence mining and pattern recognition algorithms may be applied to symbolic trajectories to discover common movement patterns and behavioral trends.

Symbolic trajectories may be seen as a simplified form of semantic trajectories 306. In other words, semantic trajectories 306 may capture a richer and more detailed representation of movement data, including complex relationships between entities and attributes.

Symbolic trajectories may be excellent building blocks to create semantic trajectory 306. Each label within the symbolic trajectory may be further enhanced with more data. For example, the label “work” could be enhanced with the location of the work, the type of work, or the people that the user was working with. Semantic trajectories 306 may incorporate: detailed geographic information (POIs, road networks), contextual data (weather, traffic), user profiles and preferences, activity recognition results. Symbolic trajectories may offer simplicity and efficiency, while semantic trajectories 306 may provide greater expressive power.

As noted above, geometric trajectories 302 may be the raw data, typically represented as a sequence of points with coordinates (latitude, longitude) and timestamps. ML system 102 may use geometric trajectories 302 to describe the “where” and “when” of movement. Generally, geometric trajectories 302 may be precise but often may lack semantic meaning.

In some examples, the disclosed techniques contemplate utilization of symbolic trajectories that may represent an abstraction of the geometric trajectory 302, replacing raw coordinates with meaningful labels or symbols. Symbolic trajectories may describe the “what” and “why” of movement, adding context and interpretation. Symbolic trajectories may be less precise but more informative for many applications.

Symbolic information may be derived from the geometric trajectory 302 and other contextual data 118 through various processing steps described above. For example, symbolic information may be an abstraction of aspects of geometric trajectory 302, including but not limited to, names of routes traversed, cardinal directions, speed profiles, current weather at moving entity, and the like. To overcome the limitations of geometric trajectories 302, the semantic trajectory module 110 may, for example, match the coordinates of the geometric trajectory 302 against a road network database (e.g., OpenStreetMap). Semantic trajectory module 110 may replace the sequence of coordinates by the names of the roads or routes that were traversed (e.g., “Main Street,” “Highway 101”, etc.).

As noted above, by using symbolic abstraction, the ML system 102 may simplify analysis of the path taken and may simplify comparison of semantic trajectories 306 based on route similarity. The change in coordinates between consecutive points of geometric trajectories 302 may be used by the ML system 102 to calculate the direction of movement. In one example, the calculated direction may be quantized into cardinal directions (north, northwest, east, etc.). This symbolic abstraction may simplify the representation of movement direction and may simplify identification of directional patterns.

The distance and time between consecutive points of geometric trajectory 302 may be used by ML system 102 to calculate the speed. As noted above, the calculated speed may be categorized into speed profiles (e.g., slow, moderate, fast) based on predefined thresholds. This symbolic abstraction technique may abstract the continuous speed values into discrete categories, simplifying analysis of speed patterns and simplifying identification of periods of congestion or acceleration. As yet another example, the coordinates of geometric trajectory 302 and timestamps may be matched against weather data from contextual data 118. In essence, the semantic trajectory module 110 may assign the weather conditions at the location of the entity and time as labels (e.g., sun, rain, snow, ice). This symbolic abstraction may add valuable contextual information to the symbolic trajectory, allowing for analysis of movement behavior under different weather conditions. Symbolic trajectories may be easier to analyze and interpret than raw geometric trajectories 302. Symbolic labels may enable more expressive and efficient queries. Symbolic representation may facilitate the discovery of meaningful movement patterns.

The ML system 102 may use symbolic information to add context to movement data, enabling a deeper understanding of behavior. In other words, symbolic abstractions may significantly reduce the amount of data that needs to be stored and processed.

As a non-limiting example, a Vessel schema may define the structure of a database table named “Vessel,” which may store information about vessel trips. The Vessel schema may include, but is not limited to the following attributes: ID (string), Trip (point), NavigationLane (label) and Speed (real).

The ID attribute may be a unique identifier for each vessel. The Trip attribute may represent the geometric trajectory 302 of the vessel as a sequence of geographic points (latitude, longitude) obtained from AIS (Automatic Identification System) tracks. This attribute may be stored as a sequence of points. The NavigationLane attribute example may be a symbolic label indicating the navigation lane or route the vessel followed. This attribute may be derived by raw trajectory module 108 through map matching 504, which may align the AIS trajectory with a map (e.g., using Marine Traffic Graph (MTG) mapping or similar techniques). The Speed attribute may be the speed of the vessel, which may be represented as a real number. This attribute may be obtained through a classification of speed values (e.g., “slow,” “moderate,” “fast” may be converted into numeric values).

In an aspect, the query language may use regular expressions to search for specific sequences of navigation lane labels within the “Vessel” table. The syntax of the query language may include “_”, which may be a wildcard character that matches any single navigation lane label. The syntax of the query language may also include “*”, which may be a quantifier that matches zero or more occurrences of the preceding element. Literal strings (e.g., “Port of New Orleans”) should match the exact navigation lane label. An example query may be (_“Port of New Orleans”)*(_“Port of New Orleans”). In this case, the pattern in the query above may search for trips that start and end in the “Port of New Orleans.”

The expression (_“Port of New Orleans”) may mean any number of any other navigation labels, followed by “Port of New Orleans”. This expression may be used to match the starting location. The symbol “*” may mean zero or more of any navigation lane labels in between the starting and ending location. In other words, the second expression (_“Port of New Orleans”) may mean any number of any other navigation labels, followed by “Port of New Orleans”. This expression may be used to match the ending location. In other words, the query above may retrieve all rows from the “Vessel” table where the “NavigationLane” attribute matches the specified pattern.

In one example, the ML system 102 may collect AIS tracks, providing raw geometric trajectory data 302 (Trip). Furthermore, the raw trajectory module 108 may perform map matching 504 to align the geometric trajectories 302 with a map, resulting in navigation lane labels (NavigationLane). Speed data may be classified and stored as real numbers (Speed). All that data may be stored into the Vessel table. Users may formulate queries using the pattern-based query language.

The database system may evaluate the queries against the “NavigationLane” attribute of the “Vessel” table. In this example, rows that match the specified patterns may be returned as results. The query results may provide information about vessel trips that meet specific criteria (e.g., trips starting and ending in a particular port).

Advantageously, the Edges schema may define the structure of the navigation network's edges, providing the necessary information for map matching 504: Edges (Start: int, End: int, StartPos: point, EndPos: point, Curve: line, NavLaneName: text, NavLaneType: text, MaxSpeed: text). In this example, the attributes Start: int and End: int may identify the nodes that connect the edge. These attributes may be important for building the graph structure of the network. During map matching 504, the aforementioned attributes may help determine which edges are connected and therefore potential candidates for matching an observation. In addition, the StartPos: point and EndPos: point attributes may provide the geographic coordinates of the start and end nodes. Advantageously, these attributes may help calculate the distance between observations and edges.

In this example, the StartPos and EndPos may be used to assist in initial candidate edge selection. The Curve attribute may represent the geometric shape of the edge (e.g., a polyline). This attribute may be important for calculating the distance from an observation to the edge. In one example, accurate curve representation may be important for precise map matching 504. Furthermore, the NavLaneName attribute may provide the name of the road or waterway. This attribute may be used to filter or prioritize candidate edges based on known routes. This attribute may also be used to provide the symbolic label to the geometric trajectory 302 after map matching 504. The NavLaneType attribute may describe the type of road or waterway (e.g., highway, street, river). This attribute may be used to apply different map matching 504 strategies based on the type of edge. For example, highways may have stricter matching criteria than residential streets.

In simpler terms, the MaxSpeed attribute may provide the maximum allowed speed on the edge. Generally, the MaxSpeed attribute may be used to filter or prioritize candidate edges based on the speed of the observation. In one example, this attribute may also be used to detect anomalies or potential traffic violations. The observations speed may be compared to this value to add to the probability of a match.

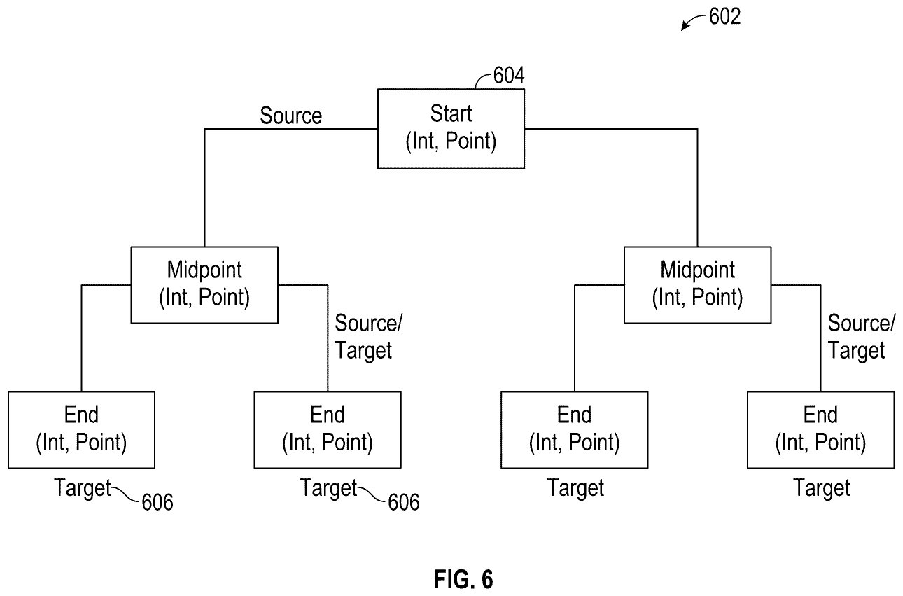

FIG. 6 is a diagram illustrating that semantic trajectories may be stored in a B-tree data structure, in accordance with one or more techniques of the disclosure. More specifically, FIG. 6 illustrates that the relation may be stored in a B-tree 602 ordered first by Source 604, then by Target fields 606 permitting efficient retrieval of successors of a node. As noted above, a B-Tree index on Edges (ordered by Source 604, then Target 606) may enable efficient retrieval of successor nodes for a given node in the navigation network. So, in this case, the B-tree index may be important for graph traversal during map matching 504 and route planning. A B-tree index may be created on the Edges relation, with the Start attribute as the primary key and the End attribute as the secondary key. In other words, this index may be sorted first by the Start node ID and then, within each Start node's entries, by the End node ID. Given a Start node ID, the B-tree 602 shown in FIG. 6 may allow for fast retrieval of all edges originating from that node (i.e., all successor nodes). B-trees 602 may be efficient for range queries, which may be useful for finding edges within a specific range of node IDs. The B-tree 602 may allow for fast lookups of the edges that are connected to a specific node.

In an aspect, an R-Tree index EdgeIndex_Box_rtree on Curve bounding boxes may be used to accelerate spatial queries on the Curve attribute of the Edges relation. This is essential for quickly identifying candidate edges that are close to a given observation point during map matching 504. An R-tree index may be created, storing the bounding boxes of the Curve (line) attribute of each edge. More specifically, R-trees may be spatial index structures designed for efficient range and nearest-neighbor queries on spatial data. R-trees may quickly identify edges whose bounding boxes intersect or are close to a given query point or region. By using bounding boxes, the R-tree may significantly reduce the number of edges that need to be examined during map matching 504. The R-tree may allow for fast lookups of edges that are within a certain distance of a given point. A relation EdgeIndex may be used to link the R-tree index entries to the corresponding records in the Edges relation. This relation may allow for efficient retrieval of the full edge information after a spatial query using the R-tree. The EdgeIndex relation may store the R-tree index entry identifier and the corresponding primary key (or row ID) of the Edges relation. This relation may allow the system to find the full Edge record, after the R-tree has found the bounding box that contains the observation. The EdgeIndex relation may enable fast retrieval of the complete edge information (including Start, End, NavLaneName, etc.) after a spatial query. This relation may simplify the maintenance of the R-tree index and the Edges relation.

Input for the map matching 504 may be a relation constructed from the raw observations with schema Trajectories (MoverId: int, Trip: point, Curve: line). The MoverId attribute may be a unique identifier for the moving entity (e.g., vehicle, vessel). The Trip attribute may be a sequence of location points representing the trajectory. Finally, the Curve attribute may be a line representing the trajectory.

In an aspect, the Trajectories relation may store the raw location observations that may be used as input for map matching 504. In this context, the Curve attribute may be used to store the line that is generated from the points within the trip. Significant time breaks in the observations may trigger the creation of a new trajectory. Essentially, trajectory segmentation 508 may help to separate distinct trips and may improve the accuracy of map matching 504. In this case, the trajectories relation may provide a structured format for the raw observation data. In other words, the trajectories relation may enable efficient management of multiple trajectories from different moving entities.

In an example, the ML System 102 may use SymTrajectories schema which may extend the raw trajectory data with a symbolic representation: SymTrajectories (MoverId: int, Trip: point, Curve: line, SymTrajectory: string). In this example, the MoverId attribute may be a unique identifier for the moving entity. In this example, the Trip attribute may be the original sequence of location points representing the trajectory. Specifically, the Curve attribute may be a line representing the trajectory. The SymTrajectory attribute may be the symbolic trajectory. This attribute may represent the symbolic trajectory as a sequence of time intervals and labels. The symbolic trajectory may represent route names, cardinal directions, speed profiles, location types, as well as combinations of the above. The route names may be a sequence of road or waterway names (e.g., “Highway 101, Main Street, River”). The cardinal directions may be a sequence of directions (e.g., “North, Northwest, West”). The speed profiles may be a sequence of speed categories (e.g., “Slow, Moderate, Fast”). The location types may be a sequence of location types (e.g., “Residential, Commercial, Industrial”). The combination of the above may be represented as “Highway 101-Fast-North, Main Street-Slow-West, River-Moderate”. In an aspect, the SymTrajectories relation may enable various behavior analytics tasks that may be performed by the interpretation system 402 shown in FIG. 4.

Referring back to FIG. 4, in an aspect, the interpretation system 402 may be configured to perform behavior analytics 410. The behavior analytics 410 is the process of collecting and analyzing data about how entities behave. The objectives of the behavior analytics 410 may include identification of anomalies, patterns, and trends that may provide valuable insights. In an aspect, interpretation system 402 may track the movement or actions of a single entity over time. For example, interpretation system 402 may be tracking a vehicle's movement on a map. Analyzing semantic trajectories 306 may reveal patterns in a behavior of an entity, such as, but not limited to their preferred routes. The term “Pattern of Life” (PoL) refers to the typical routines and habits of an individual entity. Determining the PoL may involve identifying recurring patterns in daily, weekly, or monthly activities of an entity. PoL analysis may be used to understand normal behavior and detect deviations that may indicate something unusual. In addition, interpretation system 402 may track the movements and interactions of multiple entities simultaneously. For example, interpretation system 402 could be tracking the flow of traffic in a city.

In an example, interpretation system 402 may perform structured behavioral pattern analysis, particularly in the context of movement trajectories, which may extract meaningful and interpretable patterns from the structured data described above, such as the SymTrajectories relation. The objective of such analysis may be to go beyond simply observing where entities move, but rather determining how they move and why. Interpretation system 402 may discover common paths and areas of high usage within a space. In a non-limiting example, the interpretation system 402 may analyze semantic trajectory 306 data to identify frequently occurring sequences of locations or trajectory segments. This kind of analysis may reveal popular routes, areas where entities tend to stop, and overall spatial usage patterns. It should be noted that the structured behavioral pattern analysis may be employed by interpretation system 402 to detect anomalous movement patterns and/or to identify high-traffic areas. In an aspect, interpretation system 402 may break down complex movement trajectories into fundamental, reusable movement components (primitives). In an example, interpretation system 402 may define “movement primitives” as basic units of motion (e.g., straight line, turn, stop, acceleration). In an aspect, the interpretation system 412 may represent each semantic trajectory 306 as a sequence of these primitives. In addition, interpretation system 402 may quantify these primitives (e.g., angle of turn, speed of movement, etc.). The disclosed interpretation system 402 may enable robots to navigate complex environments by combining learned movement primitives. Instead of just recording a series of GPS coordinates (time series data 116), the analysis performed by interpretation system 402 may use contextual data 118 to identify segments of the trajectory as “move forward at constant speed,” “turn right sharply,” “stop for 30 seconds,” and so on.

Advantageously, interpretation system 402 may automatically learn the set of movement primitives from the structured semantic trajectory 306 data itself. In one example, interpretation system 402 may employ a machine learning technique, such as but not limited to sparse dictionary learning. As noted above, interpretation system 402 may represent semantic trajectories 306 as a combination of a small number of the primitives. This technique may learn the optimal set of primitives that may best reconstruct the observed semantic trajectories 306. Advantageously, interpretation system 402 may automate the process of identifying movement patterns without manual definition of primitives. The interpretation system 402 may adapt to different movement styles and environments. For example, interpretation system 402 may analyze a large dataset of walking trajectories and may automatically discover that the common movement primitives include “short forward step,” “long stride,” “90-degree turn,” and “brief pause.” In an aspect, interpretation system 402 may validate the learned movement primitives and use these primitives for anomaly detections and for future predictions. For example, interpretation system 402 may reconstruct past semantic trajectories 306 by combining the extracted primitives and may predict future semantic trajectories 306 by extrapolating from the observed sequence of primitives. For example, interpretation system 402 may anticipate future traffic flow based on current movement patterns of a plurality of entities.

In an aspect, recommendation system 404 may play a role of a trajectory planner that blends knowledge-based reasoning, context awareness, and agent-based planning to generate optimal paths within a complex operational domain. In one example, recommendation system 404 may treat entities within the operational domain as autonomous agents with their own goals, preferences, and behaviors. Recommendation system 404 may simulate the interactions and movements of these agents to predict and optimize semantic trajectories 306 based on the structured trajectory data described above. Advantageously, recommendation system 404 may capture dynamic interactions and emergent behaviors that traditional planning methods might miss. In an aspect, recommendation system 404 may enhance trajectory planning by incorporating contextual factors and supplemental data, such as, but not limited to, domain-specific knowledge. Contextual data 118 may indicate to the recommendation system 404 that individual agents may have preferred routes, destinations, or movement styles. The actions of other agents may influence an optimal path of an agent.

In an aspect, crowded areas may necessitate alternative routes to avoid congestion. In some cases, agents may need to reach their destinations within specific time windows. At least in those cases, the starting point of semantic trajectory 306 may be an important factor. Weather, terrain, and other environmental factors may all impact traversal costs. Furthermore, recommendation system 404 may utilize the specific characteristics of the operational domain (domain knowledge), such as, but not limited to, road networks, building layouts, or airspace structures. The domain knowledge may also include information about landmarks, obstacles, traffic patterns, and other relevant features. In one example of specific implementation, recommendation system 404 may generate a ranked list of potential trajectories, providing explanations for the ranking. As an example of ranking criteria, shorter paths or minimization of traversal cost may be preferred. Minimizing traversal cost may include factors such as, but not limited to, time (e.g., the duration of the trajectory), fuel (e.g., energy consumption), risk (e.g., potential hazards along the path). Advantageously, recommendation system 404 may take into account the context and domain knowledge to calculate these costs. In some examples, recommendation system 404 may provide justifications for the ranking, explaining why certain trajectories may be preferred over others. For example, recommendation system 404 may provide a recommendation: “Trajectory A is ranked higher because it avoids congested areas and reduces travel time by 15%.” In an aspect, recommendation system 414 may further re-evaluate rankings with further input from the interpretation system 402 (e.g., behavioral analytics 410). In other words, the output of interpretation system 402 may be used to refine the trajectory ranking. This may allow recommendation system 404 to adapt to changing conditions and new information. For example, if an anomaly, such as a traffic accident is detected, interpretation system 402 may inform the recommendation system 404 to re-evaluate the trajectories, and rank routes that avoid the accident higher. To summarize, recommendation system 404 may represent entities as individual agents, each with their own goals, preferences, and initial location. Recommendation system 404 may use the collected contextual information, such as, but not limited to agent density, environmental conditions, and time constraints. In addition, recommendation system 404 may use domain knowledge to generate potential trajectories and calculate their traversal costs. In some examples, recommendation system 404 may simulate the movements of agents, taking into account their interactions and the contextual factors. The recommendation system 404 may rank the trajectories based on distance and traversal cost, providing explanations for the ranking. The chosen trajectory may be executed, and the process may be repeated as needed. As an example, the recommendation system 404 may plan safe and efficient routes in dynamic traffic environments.

FIG. 7 illustrates a framework for identifying anomalous trajectories by leveraging data from multiple sources, in accordance with one or more techniques of the disclosure. During the data acquisition stage 702, the ML system 102 may gather raw data from various sources relevant to the trajectories being analyzed. The AIS (Automatic Identification System) is primarily used for maritime vessel tracking, providing location, speed, and other vessel information. The contextual data 118 may include but is not limited to satellite imagery, radar data, and other remote sensing information that may provide contextual insights into the environment. The outcome of the data acquisition 702 stage may be a collection of raw data from multiple sources. During the preprocessing stage 704, the ML system 102 (e.g. raw trajectory module 108) may clean and prepare the raw data for subsequent analysis. The data cleaning 502 tasks may include but are not limited to handling missing values, noise removal, and outlier detection. In one example, the preprocessing 704 may also include converting data into a consistent format, such as time series or spatial coordinates. The ML system 102 may align data from different sources based on timestamps. The outcome of the preprocessing stage 704 may be clean and consistent data ready for feature extraction 706. Next, ML system 102 may perform trajectory feature extraction 706. During this stage ML system 102 may extract meaningful features from the preprocessed trajectory data. The variety of extracted features may include, but are not limited to, spatial features, temporal features and contextual features. The spatial features may include but are not limited to, location coordinates, distance traveled, heading, and the like. The temporal features may include, but are not limited to, speed, acceleration, time intervals between points, and the like. The contextual features may include environmental conditions, traffic density, and the like. In an aspect, the feature extraction 706 stage may provide a set of relevant features that represent the characteristics of the trajectories. In an aspect, the ML system may generate Attributed Graph (AG) 710.

In an aspect, semantic trajectory mining module 111 of the ML system 102 may convert the extracted features into a numerical representation (embeddings) that may be processed by machine learning models. For example, semantic trajectory mining module 111 may traverse AG 710 to encode time-related features into a vector space. In addition, semantic trajectory mining module 111 may encode environmental and other contextual information into a vector space. The numerical embeddings may represent the temporal aspects (e.g., temporal encoding 716) and contextual aspects (contextual encoding 714) of the semantic trajectories 306. As shown in FIG. 7, the numerical embeddings (e.g., contextual encoding 714 and temporal encoding 716) may be fed as input data into ML model 718 that may have hierarchical S-T (Spatial-Temporal) layers. In other words, ML model 718 may be a component of semantic trajectory mining module 111 that may process the embedded features to capture the sequential dependencies and relationships within and across different data sources. Advantageously, the ML model 718 may process data from multiple input sources simultaneously. In an aspect, ML model 718 may be a layered model that captures patterns at different levels of abstraction. As used herein the term “S-T layers” refers to specialized layers designed to process spatial and temporal data. In an aspect, ML model 718 may generate learned representations that capture the complex patterns in semantic trajectories 306. Next, semantic trajectory mining module 111 may enhance the learned representations by incorporating relationships between different data sources and supplementary information. Source embedding 720 process may involve correlating trajectory data from different sources to generate source embeddings 720 that capture their interdependencies. For example, semantic trajectory mining module 111 may correlate AIS data with satellite imagery to understand how vessel movements relate to environmental conditions. Supplementary data embedding 722 process may involve combining supplementary data from various sources, such as, but not limited to weather information, to generate supplementary data embeddings 722 that provide additional contextual information. For example, semantic trajectory mining module 111 may combine weather data with traffic data to understand the impact of weather on traffic flow. The outcome of the source embedding 720 and supplementary data embedding 722 may include embeddings that capture the relationships between different data sources and supplementary information. As shown in FIG. 7, semantic trajectory mining module 111 may perform information fusion 724 by combining the source embeddings 720 and supplementary data embeddings 722 into a single, unified representation. In various implementations, semantic trajectory mining module 111 may use techniques like concatenation, weighted averaging, or attention mechanisms to integrate the different embeddings.

As a result, a fused representation may capture all relevant information from the various data sources. Finally, semantic trajectory mining module 111 may employ the fused representation to classify trajectories as normal or anomalous (trajectory anomalies 728). In one example, semantic trajectory mining module 111 may apply a classification algorithm (e.g., support vector machine, neural network) to the fused embeddings. The final classification step may generate a classification label (normal or anomalous (trajectory anomalies 728)) for each trajectory.

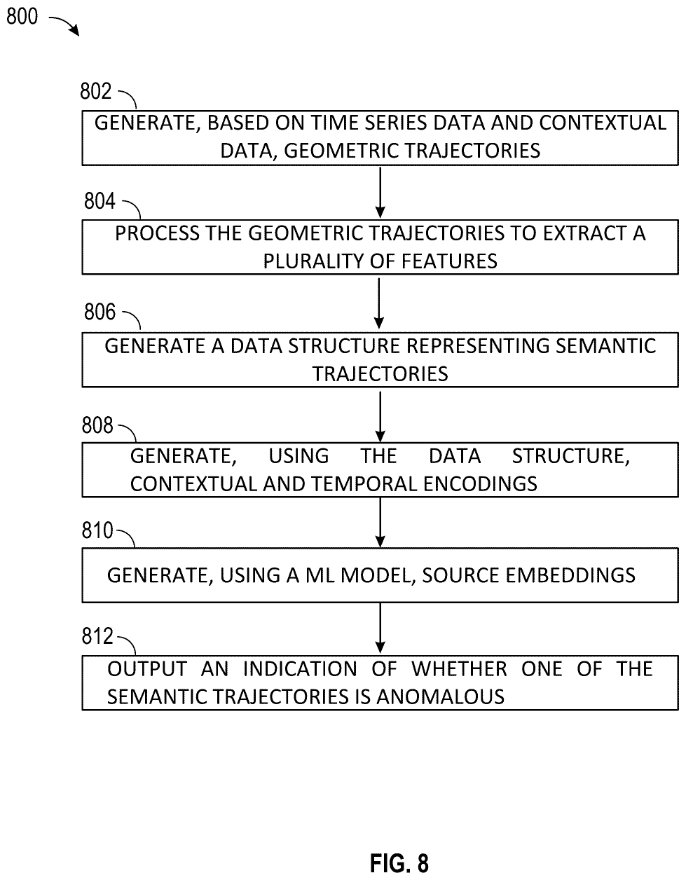

FIG. 8 is a flowchart illustrating an example mode of operation for a machine learning system, according to one or more techniques described in this disclosure. Although described with respect to computing system 200 of FIG. 2 having processing circuitry 243 that executes computing system 100, mode of operation 800 may be performed by a computing system with respect to other examples of machine learning systems described herein.

In mode of operation 800, processing circuitry 243 executes computing system 100. Computing system 100 may generate, based on multi-source time series data and contextual data, one or more geometric trajectories representing movement of an entity (802). The term “multi-source time series data,” as used herein, refers to the various sensor data or measurements that may contribute to the raw (geometric) trajectory. Next step may involve computing system 100 processing the one or more geometric trajectories to extract a plurality of features from the one or more geometric trajectories and from the contextual data (804). The plurality of features may include at least temporal features, spatial features and contextual features. For example, ML system 102 may use raw trajectory module 108 to process and refine the raw sensor data (e.g., time series data 116) to produce a more accurate and complete representation of the geometric trajectory 302, in accordance with techniques described herein. A data structure representing one or more semantic trajectories may be generated (806). Each of the one or more semantic trajectories 306 may include at least some of the temporal features, spatial features and the contextual features. In one example, the data structure may comprise a B-tree data structure 602 shown in FIG. 6. The next step may include the computing system 100 generating, using the data structure, contextual encodings and temporal encodings (808). The numerical embeddings may represent the temporal aspects (e.g., temporal encoding 716) and contextual aspects (contextual encoding 714) of the semantic trajectories 306. As shown in FIG. 7, the computing system 100 may process, with a machine learning model, the contextual encodings and the temporal encodings to generate source embeddings representing interdependencies between the semantic trajectories (810). In an aspect, ML model 718 may generate learned representations that capture the complex patterns in semantic trajectories 306. The last step may include the computing system 100 outputting, based on the one or more source embeddings, an indication of whether one of the semantic trajectories is anomalous (812). The output data may include anomaly data 122 as well as interpretations and/or recommendations generated by semantic trajectory exploitation module 112, for example.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in computer-readable media, such as a computer-readable storage medium, containing instructions. Instructions embedded or encoded in one or more computer-readable storage mediums may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A method for time series anomaly detection, the method comprising:
generating, based on multi-source time series data and contextual data, one or more geometric trajectories representing movement of an entity;
processing the one or more geometric trajectories and the contextual data to extract a plurality of features, wherein the plurality of features include one or more of temporal features, spatial features and contextual features;
generating a data structure representing one or more semantic trajectories, wherein each of the one or more semantic trajectories includes at least one of the one or more temporal features, spatial features and the contextual features;
generating, using the data structure, based on the contextual features, one or more contextual encodings corresponding to the one or more semantic trajectories and generating, based on the temporal features, one or more temporal encodings corresponding to the one or more semantic trajectories;
processing, with a machine learning model, the one or more contextual encodings and the one or more temporal encodings to generate one or more source embeddings representing one or more interdependencies between the one or more semantic trajectories; and
outputting, based on the one or more source embeddings, an indication of whether one of the semantic trajectories is anomalous.

2. The method of claim 1, further comprising:
generating, using the one or more source embeddings, a classification label for each of the one or more semantic trajectories, wherein the classification label comprises at least one of a normal trajectory and anomalous trajectory,
wherein the indication of whether the one of the semantic trajectories is anomalous comprises the classification label corresponding the one of the semantic trajectories.

3. The method of claim 1, wherein processing the one or more geometric trajectories further comprises:
segmenting the one or more geometric trajectories into one or more segments; and
assigning a contextual label to each of the one or more segments.

4. The method of claim 1, wherein the contextual data is obtained from a plurality of sources and wherein a different weight is assigned to each of the plurality of sources of the contextual data to generate one or more weighted contextual features.

5. The method of claim 4, further comprising:
analyzing the one or more semantic trajectories to interpret behavior of one or more entities associated with the corresponding one or semantic trajectories; and
generating, based on the interpreted behavior, a recommendation for the one or more entities.

6. The method of claim 5, wherein analyzing the one or more semantic trajectories to interpret behavior of the one or more entities further comprises:
combining the one or more weighted contextual features with one or more behavior features.

7. The method of claim 5, wherein analyzing the one or more semantic trajectories to interpret behavior of the one or more entities further comprises:
clustering at least two of the one or more semantic trajectories that exhibit similar behavioral patterns into one or more groups of semantic trajectories.

8. The method of claim 1, wherein each of the one or more semantic trajectories comprises a semantic trajectory model.

9. The method of claim 1, wherein each of the one or more semantic trajectories comprises one or more symbolic trajectories.

10. A computing system for time series anomaly detection, the computing system comprising:
processing circuitry in communication with storage media, the processing circuitry configured to execute a machine learning system configured to:
generate, based on multi-source time series data and contextual data, one or more geometric trajectories representing movement of an entity;
process the one or more geometric trajectories and the contextual data to extract a plurality of features, wherein the plurality of features include one or more of temporal features, spatial features and contextual features;
generate a data structure representing one or more semantic trajectories, wherein each of the one or more semantic trajectories includes at least one of the one or more temporal features, spatial features and the contextual features;
generate, using the data structure, based on the contextual features, one or more contextual encodings corresponding to the one or more semantic trajectories and generate, based on the temporal features, one or more temporal encodings corresponding to the one or more semantic trajectories;
process, with a machine learning model, the one or more contextual encodings and the one or more temporal encodings to generate one or more source embeddings representing one or more interdependencies between the one or more semantic trajectories; and
output, based on the one or more source embeddings, an indication of whether one of the semantic trajectories is anomalous.

11. The system of claim 10, wherein the machine learning system is further configured to:
generate, using the one or more source embeddings, a classification label for each of the one or more semantic trajectories, wherein the classification label comprises at least one of a normal trajectory and anomalous trajectory,
wherein the indication of whether the one of the semantic trajectories is anomalous comprises the classification label corresponding the one of the semantic trajectories.

12. The system of claim 10, wherein the machine learning system configured to process the one or more geometric trajectories is further configured to:
segment the one or more geometric trajectories into one or more segments; and
assign a contextual label to each of the one or more segments.

13. The system of claim 10, wherein the contextual data is obtained from a plurality of sources and wherein a different weight is assigned to each of the plurality of sources of the contextual data to generate one or more weighted contextual features.

14. The system of claim 13, wherein the machine learning system is further configured to:
analyze the one or more semantic trajectories to interpret behavior of one or more entities associated with the corresponding one or semantic trajectories; and
generate, based on the interpreted behavior, a recommendation for the one or more entities.

15. The system of claim 14, wherein the machine learning system configured to analyze the one or more semantic trajectories to interpret behavior of the one or more entities is further configured to:
combine the one or more weighted contextual features with one or more behavior features.

16. The system of claim 14, wherein the machine learning system configured to analyze the one or more semantic trajectories to interpret behavior of the one or more entities is further configured to:
cluster at least two of the one or more semantic trajectories that exhibit similar behavioral patterns into one or more groups of semantic trajectories.

17. The system of claim 10, wherein each of the one or more semantic trajectories comprises a semantic trajectory model.

18. The system of claim 10, wherein each of the one or more semantic trajectories comprises one or more symbolic trajectories.

19. Non-transitory computer-readable storage media having instructions encoded thereon for time series anomaly detection, the instructions configured to cause processing circuitry to:
generate, based on multi-source time series data and contextual data, one or more geometric trajectories representing movement of an entity;
process the one or more geometric trajectories and the contextual data to extract a plurality of features, wherein the plurality of features include one or more of temporal features, spatial features and contextual features;
generate a data structure representing one or more semantic trajectories, wherein each of the one or more semantic trajectories includes at least one of the one or more temporal features, spatial features and the contextual features;
generate, using the data structure, based on the contextual features, one or more contextual encodings corresponding to the one or more semantic trajectories and generate, based on the temporal features, one or more temporal encodings corresponding to the one or more semantic trajectories;
process, with a machine learning model, the one or more contextual encodings and the one or more temporal encodings to generate one or more source embeddings representing one or more interdependencies between the one or more semantic trajectories; and
output, based on the one or more source embeddings, an indication of whether one of the semantic trajectories is anomalous.

20. The storage media of claim 19, wherein the instructions are further configured to cause the processing circuitry to:
generate, using the one or more source embeddings, a classification label for each of the one or more semantic trajectories, wherein the classification label comprises at least one of a normal trajectory and anomalous trajectory,
wherein the indication of whether the one of the semantic trajectories is anomalous comprises the classification label corresponding the one of the semantic trajectories.
